(19) United States
(12) Patent Application Publication
(10) Pub. No.: US 2025/0206578 A1
(43) Pub. Date: Jun. 26, 2025

(54) WORK MACHINE

(71) Applicant: SUMITOMO HEAVY INDUSTRIES, LTD., Tokyo (JP)

(72) Inventor: Yasuhiro YAMAMOTO, Yokosuka-shi (JP)

(21) Appl. No.: 18/986,277

(22) Filed: Dec. 18, 2024

(30) Foreign Application Priority Data
Dec. 22, 2023 (JP) 2023-216660

(51) Int. Cl. B66C 13/06; B66C 13/46

(52) U.S. Cl. CPC B66C 13/066; B66C 13/46

(57) ABSTRACT

A work machine includes a speed detection unit that detects a shaking speed in a predetermined axial direction of a suspended object suspended from a first member. Shaking of the suspended object is reduced by performing drive control to move the first member in the axial direction, based on a detection result of the speed detection unit.

### CROSS-REFERENCE TO RELATED APPLICATIONS

This application claims priority to Japanese Patent Application No. 2023-216660, filed on Dec. 22, 2023, which is incorporated by reference herein in its entirety.

### BACKGROUND

### Technical Field

A certain embodiment of the present invention relates to a work machine.

### Description of Related Art

The related art discloses a technique for suppressing shaking of a suspended load at a transport end position when a suspended object is transported.

### SUMMARY

According to an embodiment of the present invention, there is provided a work machine including a speed detection unit that detects a shaking speed in a predetermined axial direction of a suspended object suspended from a first member. Shaking of the suspended object is reduced by performing drive control to move the first member in the axial direction, based on a detection result of the speed detection unit.

### BRIEF DESCRIPTION OF THE DRAWINGS

FIG. 1 is a side view of a work machine according to an embodiment of the present invention.

FIG. 2 is a plan view illustrating the work machine from which a portion is omitted according to the embodiment of the present invention.

FIG. 3 is a partially enlarged view of the work machine illustrated in FIG. 1.

FIG. 4 is a block diagram illustrating a functional configuration of the work machine according to the embodiment of the present invention.

FIG. 5 is a flowchart illustrating a control process in a shaking reduction mode.

FIG. 6 is a view illustrating an example of a trajectory when shaking of a suspended object is viewed from above.

FIG. 7 is a time chart illustrating an amplitude and a speed of the shaking in FIG. 6.

FIGS. 8A to 8D are views for describing a movement example of a tip of a boom for shaking reduction control and a suspended object, and illustrate states at first to fourth timings.

### DETAILED DESCRIPTION

Even when a boom is stopped, the suspended object may be shaken due to some factors. The present inventors have found that there is a demand for reducing the shaking of the suspended object even in this case.

It is desirable to provide a work machine capable of further reducing a shaking of a suspended object.

Hereinafter, embodiments of the present invention will be described in detail with reference to the drawings. In the present specification, an “X-axis direction” indicates a direction in which a tip of a boom 2 moves when the boom 2 is turned from a state where the boom 2 is stopped (tangential direction of a turning circle of the tip). A “Y-axis direction” indicates a horizontal component of a direction in which the tip of the boom 2 moves when the boom 2 performs derricking and lowering operations from the state where the boom 2 is stopped. In addition, “left, right, front, and rear” indicate left, right, front, and rear when viewed from an occupant of a work machine 1.

### Configuration of Work Machine

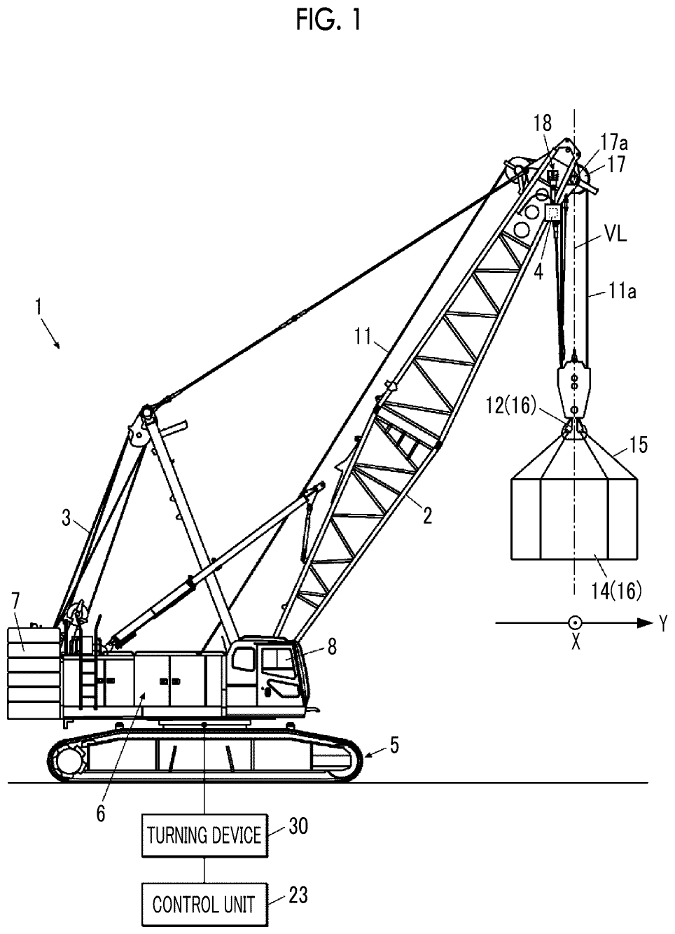

FIG. 1 is a side view of the work machine 1 according to the present embodiment.

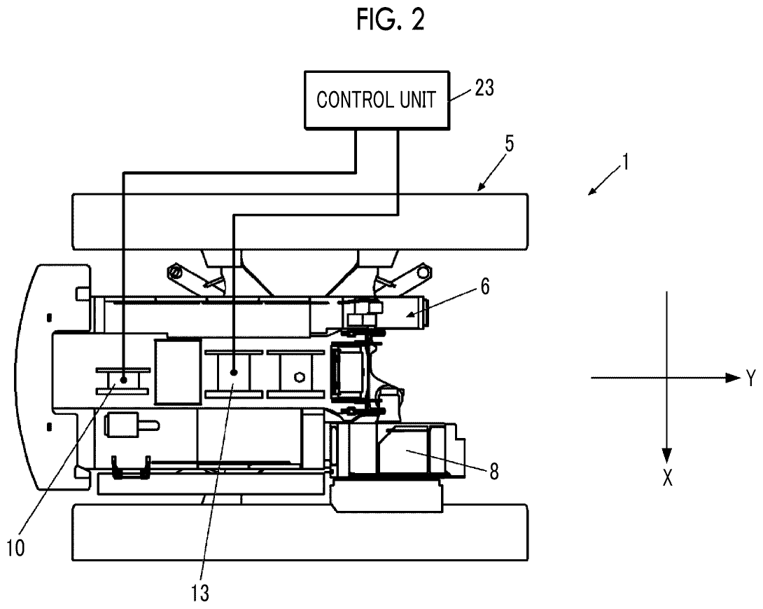

FIG. 2 is a plan view illustrating the work machine 1 from which a portion (boom 2, derricking rope 3, and the like) is omitted according to the embodiment of the present invention.

As illustrated in FIGS. 1 and 2, the work machine 1 is a so-called mobile crawler crane. Specifically, the work machine 1 includes a self-propelled crawler-type lower traveling body 5 and a rotating platform 6 mounted on the lower traveling body 5 to be capable of turning. A boom 2 is attached to a front side of the rotating platform 6 so that a derricking operation can be performed. A counterweight 7 that balances weights of the boom 2 and a suspended load is attached to a rear portion of the rotating platform 6. A cabin 8 in which an operator sits and manipulates the work machine 1 is disposed in a front right portion of the rotating platform 6. A derricking operation of the boom 2 is performed in such a manner that a derricking winch 10 winds or unwinds a derricking rope 3. The boom 2 corresponds to an example of a first member according to the present invention.

One end of a hoisting rope 11 is connected to a hook 12, and the hook 12 is suspended by the hoisting rope 11 wound around a point sheave 17 of the tip of the boom 2. The other end of the hoisting rope 11 is wound around a hoisting winch 13 on the rotating platform 6, and the hoisting rope 11 is wound or unwound by driving the hoisting winch 13 so that the hook 12 is raised or lowered. The suspended load 14 is suspended from the hook 12 by a suspending material 15 such as a string and a chain. In the present embodiment, the hook 12 and the suspended load 14 form a suspended object 16 suspended from the boom 2. When the suspended load 14 is not suspended from the hook 12, the suspended object 16 is only the hook 12.

In a state where the boom 2 is stopped and the suspended object 16 is not shaken, the suspended object 16 is located vertically below a center 17a of the point sheave 17 disposed in the tip of the boom 2. This position will be referred to as a reference position. The reference position is a position on a reference line VL (refer to FIG. 1) extending vertically downward from the center 17a of the point sheave 17 when viewed from a side, and corresponds to a position on an imaginary line extending vertically downward from a center position of the point sheave 17 in a left-right direction when viewed from a front side.

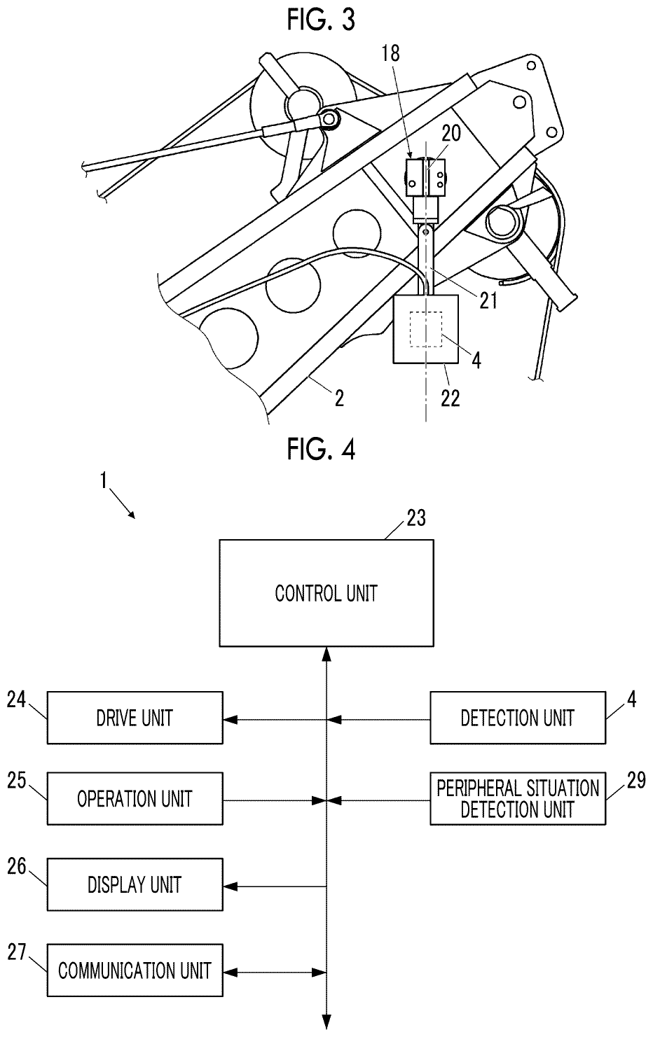

FIG. 3 is a partially enlarged view of the work machine 1 illustrated in FIG. 1, and is a view illustrating an attachment structure of a detection unit 4.

The work machine 1 includes the detection unit 4 that detects the suspended object 16. The detection unit 4 corresponds to an example of a speed detection unit according to the present invention. For example, the detection unit 4 includes a camera that acquires an image of the suspended object 16 by imaging the suspended object 16, and a function module that calculates a position, a positional change, and a speed of the suspended object 16 from the image. The function module can calculate a distance to the suspended object 16 from data of an unwinding amount of the hoisting rope 11, and can calculate a position and a speed of the suspended object 16 in the X-axis direction and the Y-axis direction from a displacement amount of the suspended object 16 and the distance in the image. Without including the above-described function module, the detection unit 4 may be configured to transmit image data acquired by the camera to a control unit 23. The control unit 23 may be configured to calculate the position, the positional change, and the speed of the suspended object 16, based on the data. The camera of the detection unit 4 may be replaced with a light detection and ranging (LiDAR) or a millimeter wave radar. In addition, the detection unit 4 may be replaced with a positioning device of a global navigation satellite system (GNSS) provided in the suspended object 16 or in a vicinity thereof.

As illustrated in FIGS. 1 and 3, the detection unit 4 may be suspended via an attachment tool 18 on the tip side of the boom 2. The attachment tool 18 includes a base portion 20 fixed to the boom 2, a column 21 whose one end is supported to be pivotable by the base portion 20, and a cover 22 fixed to the other end of the column 21. The attachment tool 18 holds a posture in which the column 21 and the cover 22 face downward by own weights regardless of a derricking operation of the boom 2. The detection unit 4 is housed inside the cover 22. As a result, the detection unit 4 holds a posture facing downward as in the column 21 and the cover 22 of the attachment tool 18 regardless of the derricking operation of the boom 2.

FIG. 4 is a block diagram illustrating a functional configuration of the work machine 1.

As illustrated in FIG. 4, the work machine 1 includes a control unit 23, a drive unit 24, an operation unit 25, a display unit 26, a communication unit 27, a detection unit 4, and a peripheral situation detection unit 29.

The drive unit 24 is a drive source that operates each unit of the work machine 1, and includes the derricking winch 10, a hoisting winch 13, a turning device 30 of the rotating platform 6, and various other motors and actuators.

The operation unit 25 is operation means used by an operator to perform various operations. For example, the operation unit 25 includes a handle, a pedal, a lever, various buttons, and the like, and outputs an operation signal corresponding to operation contents thereof to the control unit 23.

For example, the control unit 23 is a computer including a central processing unit (CPU) and an interface for exchanging data or signals between a storage unit and an external device. The control unit 23 inputs an operation command from an operator via the operation unit 25, and drives the drive unit 24 in response to the operation command. In this manner, an operation of the work machine 1 according to the operation of the operator is realized.

For example, the display unit 26 is a liquid-crystal display, an organic electroluminescence display, or another display, and displays images or various types of information of the suspended object 16 and a work site around the suspended object 16, based on a display signal input from the control unit 23. The display unit 26 may be a touch panel that also serves as a portion of the operation unit 25. For example, the communication unit 27 is a communication device capable of transmitting and receiving various types of information to and from an information terminal (not illustrated).

The peripheral situation detection unit 29 detects a peripheral situation of the work machine 1. The peripheral situation detected by the peripheral situation detection unit 29 includes the presence or absence of an obstacle such as a building, a person, and a structure, and the presence or absence of an entry prohibited area. The peripheral situation detection unit 29 includes a detector that acquires a periphery image of the work machine 1, three-dimensional positioning information, or both of these, and detects an obstacle located in the periphery from the image, the positioning information, or both of these which are acquired by the detector. Furthermore, the peripheral situation detection unit 29 registers information on a preset entry prohibited area, and determines the presence or absence and the position of the entry prohibited area, based on the information. When there is a narrow space and a wide space, the peripheral situation detection unit 29 may detect the narrow space as the entry prohibited area. In addition, a process of detecting the peripheral obstacle, based on the data acquired by the detector and a process of determining the presence or absence and the position of the entry prohibited area, based on the registered information on the entry prohibited area may be performed by the control unit 23.

### Shaking Reduction Mode

An operation mode of the work machine 1 includes a shaking reduction mode for reducing shaking of the suspended object 16. The shaking reduction mode is an operation mode in which the boom 2 is automatically moved to reduce the shaking of the suspended object 16. More specifically, the shaking reduction mode is an operation mode in which the shaking of the suspended object 16 in a state where the boom 2 is stopped is reduced by stopping the boom 2 after automatically moving the boom 2 when the suspended object 16 is shaken in a state where the boom 2 is stopped.

The operation unit 25 includes a mode operation unit for causing the work machine 1 to proceed to the shaking reduction mode. The operator can cause the operation mode of the work machine 1 to proceed to the shaking reduction mode by operating the mode operation unit. As the mode operation unit, various types of operation units such as a button, a switch, or a selection operation unit on a touch panel can be adopted.

When the shaking reduction mode is selected, the detection unit 4 continuously (repeatedly at a short time interval) detects a speed of the suspended object 16 in the X-axis direction and a speed in the Y-axis direction, and transmits a detection result to the control unit 23. In addition, the control unit 23 starts a control process of the shaking reduction mode.

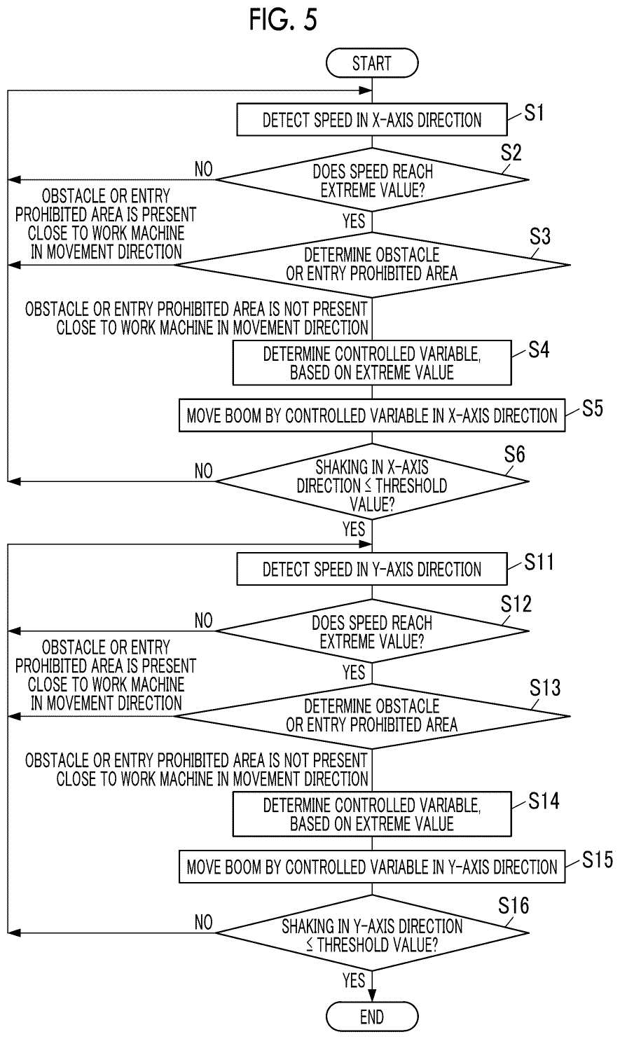

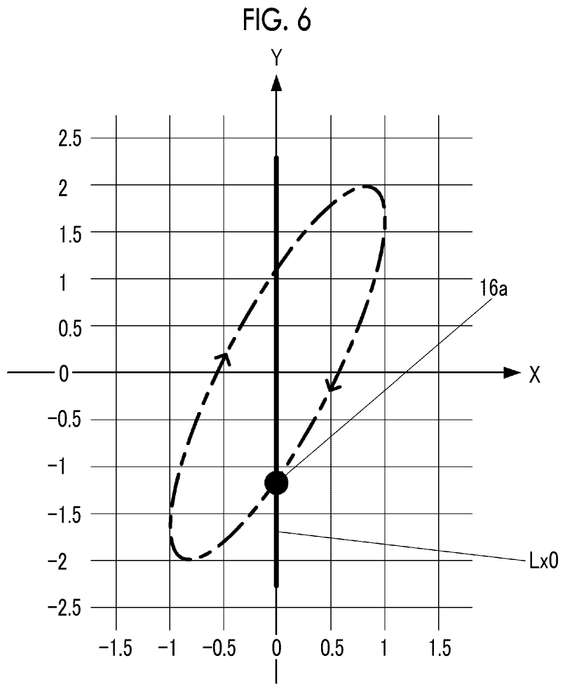

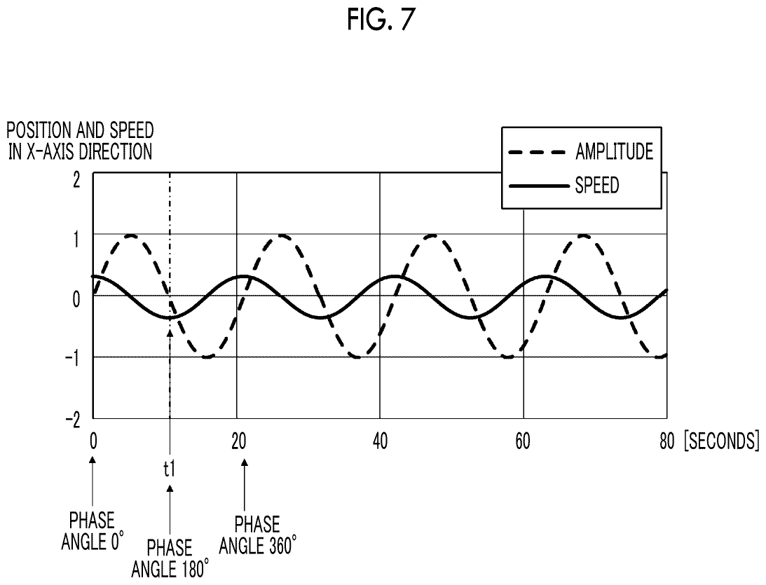

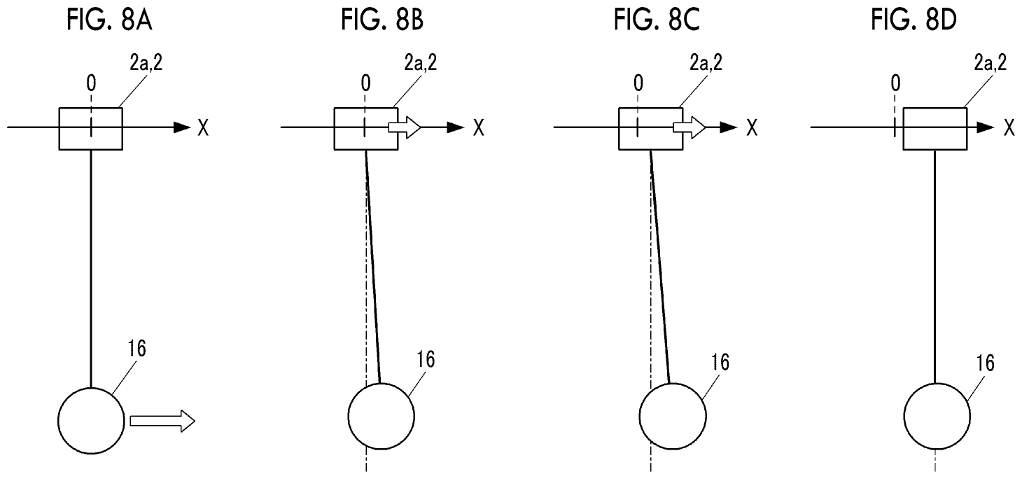

FIG. 5 is a flowchart illustrating the control process of the shaking reduction mode. FIG. 6 is a view illustrating an example of a trajectory when the shaking of the suspended object 16 is viewed from above. FIG. 7 is a time chart illustrating an amplitude and a speed of the shaking in FIG. 6. FIGS. 8A to 8D are views illustrating an example of the movement of the tip of the boom 2 and the suspended object 16 in the shaking reduction control, and illustrate states at first to fourth timings.

When the control unit 23 starts the control process of the shaking reduction mode, the control unit 23 first performs a loop process in Steps S1 and S2. In Step S1, the control unit 23 receives the speed of the suspended object 16 in the X-axis direction which is detected by the detection unit 4, and in Step S2, the control unit 23 determines whether or not the speed in the X-axis direction reaches an extreme value. The control unit 23 repeats the loop process in Steps S1 and S2 until the speed reaches the extreme value.

In determining the extreme value in Step S2, the control unit 23 determines that the speed reaches the extreme value, when a change amount of the speed is changed from positive to negative or from negative to positive. The control unit 23 may calculate the change amount of the speed from detection values of two consecutive speeds to perform the above-described determination, or may perform the above-described determination from a comparison of detection values of three or more or four or more consecutive speeds, in view of a possibility that an error occurs in the detection values of the speeds.

As illustrated in FIG. 6, the shaking of the suspended object 16 is a motion in which the shaking in the X-axis direction and the shaking in the Y-axis direction are combined. FIG. 6 illustrates that a center 16a of the suspended object 16 is displaced along a one-dot chain line due to the shaking, when viewed from above. Here, when the shaking in the X-axis direction is focused, as illustrated in FIG. 7, the amplitude and the speed in the X-axis direction are changed in a sine wave shape while a phase is shifted by 90°. When the suspended object 16 passes through a reference position on the X axis (line Lx0 of X=0 in FIG. 6) (timing t1 in FIG. 7), the speed in the X-axis direction reaches the extreme value. In other words, an absolute value of the speed in the X-axis direction is a maximum value.

When the extreme value is detected in Step S2, a timing at which a phase angle of the shaking of the suspended object 16 becomes a predetermined angle (for example, 0° or 180° in a sine wave) and a speed of the suspended object 16 in the X-axis direction at the phase angle are specified. This information is sufficient information for specifying that the shaking of the suspended object 16 in the X-axis direction can be efficiently reduced by moving the boom 2 in any way. Furthermore, the extreme value of the speed in the X-axis direction can be obtained by continuously detecting the speed in the X-axis direction even when the reference position on the X-axis is unknown. In addition, the extreme value of the speed in the X-axis direction can be detected in a time equal to or shorter than half of a period even when the period of the shaking of the suspended object 16 is long. That is, the control unit 23 can acquire information for reducing the shaking of the suspended object 16 in the X-axis direction in a short time by performing the loop process in Steps S1 and S2.

When it is determined that the speed reaches the extreme value in Step S2, the control unit 23 determines whether or not there is an obstacle or an entry prohibited area in a predetermined range in the movement direction of the suspended object 16 in the X-axis direction, based on a detection result of the peripheral situation detection unit 29 (Step S3). The above-described predetermined range is a range in which the boom 2 or the suspended object 16 approaches within an allowable distance by performing a process in Step S5 (to be described later).

When a determination result in Step S3 is YES, the control unit 23 returns the process to Step S1 to perform an operation for reducing the shaking, when the suspended object 16 moves in an opposite movement direction in the X-axis direction.

On the other hand, when the determination result in Step S3 is NO, the control unit 23 determines a controlled variable for moving the boom 2 in accordance with the extreme value of the speed of the suspended object 16 in the X-axis direction (Step S4). A direction in which the boom 2 is moved is a direction in which the suspended object 16 advances in the X-axis direction. The controlled variable includes a distance (turning angle), a speed, the number of movement times, a drive pressure (pilot pressure of the turning device 30 or the derricking winch 10, a motor pressure, or the like) for moving the boom 2, or a plurality of these factors. The control unit 23 may refer to a data table assigned in advance, and may determine the controlled variable corresponding to the extreme value of the speed. The data table shows a relationship between the controlled variable that can effectively reduce the shaking of the suspended object 16 and the extreme value of the speed in the X-axis direction. The relationship between the controlled variable and the extreme value of the speed in the X-axis direction can be obtained in advance by a test or a simulation in a manufacturer, for example. As a specific example, as the extreme value of the speed in the X-axis direction becomes greater, as the controlled variable, the control unit 23 determines a long distance, a high speed, or both of these controlled variables. In addition, the control unit 23 determines a large number of times as the controlled variable, when the extreme value of the speed in the X-axis direction is much greater and the controlled variable of the distance or the speed is excessively increased.

In Step S4, the control unit 23 may determine the controlled variable for moving the boom 2, based on the extreme value of the speed in the X direction and the period of the shaking. In this case, the period is also added to the above-described data table as a parameter. The control unit 23 holds information on a length of a load hoisting rope 11a hoisting the suspended object 16, and can calculate the period of the suspended object 16, based on the length of the load hoisting rope 11a.

When the controlled variable is determined, the control unit 23 transmits a control command to the drive unit 24 to move the boom 2 in the X-axis direction by the controlled variable (Step S5). Here, the control unit 23 turns the rotating platform 6 to move the boom 2 in the X-axis direction. The process in Step S5 is quickly performed by the control unit 23, after the speed of the suspended object 16 reaches the extreme value. Therefore, the boom 2 quickly starts moving after the speed of the suspended object 16 reaches the extreme value. There exists a time lag in the control between a timing at which the speed reaches the extreme value and a timing at which the boom 2 starts moving, but the time lag may be within no more than 2 seconds. The time may be within 1.5 seconds, may be within 1second, or may be within 0.5 seconds.

The following operations of the boom 2 and the suspended object 16 in the X-axis direction are obtained by performing the processes until Step S5. That is, as illustrated in FIGS. 8A to 8D, first, when the speed reaches the extreme value (FIG. 8A), a tip 2a of the boom 2 starts moving after a slight time lag (FIG. 8B), and the boom 2 is moved by the above-described controlled variable to reduce the shaking of the suspended object 16 (FIG. 8C). Then, the boom 2 is stopped in a state where the shaking of the suspended object 16 is substantially normalized (FIG. 8D).

Subsequently, the control unit 23 determines whether or not a magnitude of the shaking of the suspended object 16 in the X-axis direction is equal to or smaller than a threshold value (Step S6). In a case of YES, the control unit 23 may perform the process. In contrast, in a case of NO, the control unit 23 may return the process to Step S1, and may repeat the processes in Steps S1 to S5 again.

When the shaking in the X-axis direction is reduced, next, the control unit 23 proceeds to the process of reducing the shaking of the suspended object 16 in the Y-axis direction.

That is, first, the control unit 23 performs the loop process in Steps S11 and S12. In Step S11, the control unit 23 receives the speed of the suspended object 16 in the Y-axis direction which is detected by the detection unit 4, and in Step S12, the control unit 23 determines whether or not the speed in the Y-axis direction reaches the extreme value. The control unit 23 repeats the loop process in Steps S11 and S12 until the speed reaches the extreme value.

In determining the extreme value in Step S12, the control unit 23 determines that the speed reaches the extreme value, when the change amount of the speed is changed from positive to negative or from negative to positive. The control unit 23 may calculate the change amount of the speed from detection values of two consecutive speeds to perform the above-described determination, or may perform the above-described determination from a comparison of detection values of three or more or four or more consecutive speeds, in view of a possibility that an error occurs in the detection values of the speeds.

When it is determined that the speed reaches the extreme value in Step S12, the control unit 23 determines whether or not there is an obstacle or an entry prohibited area in a predetermined range in the movement direction of the suspended object 16 in the X-axis direction, based on a detection result of the peripheral situation detection unit 29 (Step S13). The above-described predetermined range is a range in which the boom 2 or the suspended object 16 approaches within an allowable distance by performing a process in Step S15 (to be described later).

When the determination result in Step S13 is YES, the control unit 23 returns the process to Step S11 to perform the operation for reducing the shaking, when the suspended object 16 moves in an opposite movement direction in the Y-axis direction.

On the other hand, when the determination result in Step S13 is NO, the control unit 23 determines the controlled variable for moving the boom 2 in accordance with the extreme value of the speed of the suspended object 16 in the Y-axis direction (Step S14). A direction in which the boom 2 is moved is a direction in which the suspended object 16 advances in the Y-axis direction. The controlled variable includes a distance (derricking and lowering angles of the boom 2), a speed, the number of movement times for moving the boom 2, or a plurality of these factors. The control unit 23 may refer to a data table assigned in advance, and may determine the controlled variable corresponding to the extreme value of the speed. The data table shows a relationship between the controlled variable that can effectively reduce the shaking of the suspended object 16 and the extreme value of the speed in the Y-axis direction. The relationship between the controlled variable and the extreme value of the speed in the Y-axis direction can be obtained in advance by a test or a simulation in a manufacturer, for example. As a specific example, as the extreme value of the speed in the Y-axis direction becomes greater, as the controlled variable, the control unit 23 determines a long distance, a high speed, or both of these controlled variables. In addition, the control unit 23 determines a large number of times as the controlled variable, when the extreme value of the speed in the Y-axis direction is much greater and the controlled variable of the distance or the speed is excessively increased.

The control unit 23 moves the boom 2 in the Y-axis direction by the controlled variable determined in Step S14 by controlling the drive unit 24 (Step S15). Here, the control unit 23 moves the tip of the boom 2 in a direction including a Y-axis direction component by performing a derricking or lowering operation on the boom 2. A process in Step S15 is quickly performed by the control unit 23 after the speed of the suspended object 16 reaches the extreme value. Therefore, the boom 2 quickly starts moving after the speed of the suspended object 16 reaches the extreme value. There exists a time lag in the control between a timing at which the speed reaches the extreme value and a timing at which the boom 2 starts moving, but the time lag may be within no more than 2 seconds. The time may be within 1.5 seconds, may be within 1 second, or may be within 0.5 seconds.

Subsequently, the control unit 23 determines whether or not a magnitude of the shaking of the suspended object 16 in the Y-axis direction is equal to or smaller than a threshold value (Step S16). In a case of NO, the control unit 23 may return the process to Step S11, and may repeat the processes in Steps S11 to S15 again.

When the determination result in Step S16 is YES, the control unit 23 completes the control process of the shaking reduction mode. Through this control process, the shaking of the suspended object 16 can be quickly and efficiently reduced.

As described above, according to the work machine 1 of the present embodiment, the detection unit 4 that detects a shaking speed of the suspended object 16 in the predetermined axial direction (specifically, the X-axis direction and the Y-axis direction) is provided. Furthermore, in the shaking reduction mode, the control unit 23 performs the drive control (Steps S5 and S15) to move the boom 2 in the axial direction, based on the detection result of the detection unit 4. In this manner, the control unit 23 reduces the shaking of the suspended object 16. Here, the control unit 23 moves the boom 2, based on the detection result of the shaking speed. Therefore, the movement of the boom 2 can be generated in accordance with the speed of the suspended object 16. In this manner, the shaking of the suspended object 16 can be efficiently and quickly reduced. In addition, in the shaking reduction modes performed multiple times, the boom 2 can be operated at the same timing in every period of the shaking. Therefore, the shaking can be stably reduced each time.

Furthermore, according to the work machine 1 of the present embodiment, in the shaking reduction mode, the boom 2 starts to be moved, based on the result that the speed of the suspended object 16 in the predetermined axial direction reaches the extreme value. The result that the speed reaches the above-described extreme value corresponds to a specific timing (timing at which a phase angle of the shaking is 0° or 180°) within a shaking period. In addition, a maximum speed of the shaking in the predetermined axial direction is specified from the extreme value. Since the boom 2 starts to be moved at this timing, the movement of the boom 2 corresponding to the shaking of the suspended object 16 can be generated, and efficient and quick reduction of the shaking can be realized. Furthermore, the result that the speed reaches the extreme value can be detected, for example, even in a stage where the reference position is unknown, and a timing at which the speed reaches the extreme value appears once within a half of the period of the shaking. Therefore, the process can quickly proceed to the control for moving the boom 2, and the reduction of the shaking can be quickly realized.

Furthermore, according to the work machine 1 of the present embodiment, in the shaking reduction mode, the control unit 23 changes the controlled variable of the drive control (Steps S5 and S15) for moving the boom 2, based on a magnitude of the extreme value of the speed of the suspended object 16 in the predetermined axial direction. In this manner, the movement of the boom 2 corresponding to the magnitude of the shaking of the suspended object 16 can be realized, and more efficient reduction of the shaking can be realized.

Furthermore, according to the work machine 1 of the present embodiment, the X-axis direction along the turning direction of the boom 2 and the Y-axis direction which is the horizontal component in the derricking and lowering direction of the boom 2 are applied as the axial direction which is the direction of the detected shaking speed and the direction for moving the boom 2. In this manner, the control for moving the boom 2 can be simplified, and stabilized reduction control of the shaking can be realized.

Furthermore, according to the work machine 1 of the present embodiment, in the shaking reduction mode, the direction in which the boom 2 is moved is determined depending on a peripheral situation of the work machine 1. Therefore, a probability that the suspended object 16 or the boom 2 approaches the obstacle or the entry prohibited area beyond the allowable distance can be reduced by performing the operation of the boom 2 in the shaking reduction mode.

According to the work machine 1 of the present embodiment, the detection unit 4 can detect the speed of the suspended object 16 when the boom 2 is stopped, and can reduce the shaking of the suspended object 16 when the boom 2 is stopped by the shaking reduction mode. According to the shaking reduction mode, when the suspended object 16 is not transported in the horizontal direction, the suspended object 16 is shaken due to some factors, and when some risks (for example, the suspended object 16 approaches the obstacle or the entry prohibited area, the work machine 1 is unstable, or the like) occur, the risks can be mitigated by reducing the shaking.

Hitherto, the embodiment of the present invention has been described. However, the present invention is not limited to the above-described embodiment. For example, in the above-described embodiment, the crawler crane has been described as an example of the work machine. However, the work machine may be various other cranes such as a gantry crane. Furthermore, the present invention can also be applied to a power excavator as the work machine, when work is carried out by suspending the suspended object with an arm in a power excavator. In the gantry crane or the like, a trolley can be applied as a first member, and in the power excavator, the arm can be applied as the first member.

In addition, in the above-described embodiment, an example has been described in which the boom 2 is moved to reduce the shaking of the suspended object 16, based on the result that the speed of the suspended object 16 in the predetermined axial direction reaches the extreme value. However, after the reference position is known, the control unit 23 can calculate a timing at which the suspended object 16 has any phase angle at that time, as well as the magnitude (amplitude, maximum speed, or the like) of the shaking, based on the period, the displacement amount of the suspended object 16 from the reference position, and the speed. Therefore, in this case, based on the shaking speed of the suspended object 16, the control unit 23 may perform control to start moving the boom 2, based on the result that the phase angle of the shaking is a predetermined angle, and may achieve an effect of reducing the shaking of the suspended object 16. As the above-described predetermined angle, any phase angle of −80° to 80° may be applied when the phase angle at which the speed reaches the extreme value is set as zero degrees.

In addition, in the above-described embodiment, an example has been described in which the result that the speed of the suspended object 16 in the predetermined axial direction reaches the extreme value is detected by comparing the speeds continuously detected before and after the result. However, when the reference position in the predetermined axial direction is known, the control unit 23 may determine that the speed in the predetermined axial direction reaches the extreme value by determining that the center of the suspended object 16 overlaps the reference position.

In addition, in the above-described embodiment, an example has been described in which the X-axis direction and the Y-axis direction are applied as the predetermined axial direction. However, for example, when the suspended object 16 performs a linear pendulum motion in a direction oblique to the X-axis in a plan view, the axial direction may be adopted as the predetermined axial direction. Furthermore, in the above-described embodiment, an example has been described in which the reduction control of the shaking in the X-axis direction and the reduction control of the shaking in the Y-axis direction are respectively performed at different timings. The reduction controls of the shaking in the two axial directions may be performed in parallel.

In addition, in the above-described embodiment, an example has been described in which the boom 2 is not moved closer to the obstacle or the entry prohibited area, when the obstacle or the entry prohibited area is close in the shaking reduction mode. However, control may be performed to suppress the number of times of movement closer to the obstacle or the entry prohibited area, or control may be performed to reduce the controlled variable in the movement closer to the obstacle or the entry prohibited area. In addition, when the boom 2 pivots multiple times in the shaking reduction mode, in the first movement control, the control for the boom 2 to avoid the movement closer to the obstacle or the entry prohibited area may be performed. In the second control for moving the boom 2, the boom 2 may be moved to the opposite side, and thereafter, in the third control and subsequent control, the control for the boom 2 to avoid the movement closer to the obstacle or the entry prohibited area may be released. In addition, when there is a narrow space and a wide space in the periphery, the direction of moving the boom 2 may be controlled, based on this peripheral situation. That is, control may be performed by regarding the narrow space as the entry prohibited area. In addition, in the above-described embodiment, a case where the speed reaches the extreme value has been described as an example of the detection result of the detection unit 4 which is a trigger for moving the boom 2 to reduce the shaking. However, for example, various conditions can be applied as the detection result of the detection unit 4 which is the above-described trigger, such as when the speed reaches an average value of peripheral values of the extreme value. In addition, details in the above-described embodiment can be appropriately changed within the scope not departing from the concept of the invention.

It should be understood that the invention is not limited to the above-described embodiment, but may be modified into various forms on the basis of the spirit of the invention. Additionally, the modifications are included in the scope of the invention.

What is claimed is:

1. A work machine comprising:
a speed detection unit that detects a shaking speed in a predetermined axial direction of a suspended object suspended from a first member,
wherein shaking of the suspended object is reduced by performing drive control to move the first member in the axial direction, based on a detection result of the speed detection unit.

2. The work machine according to claim 1,
wherein the work machine includes a control unit, a drive unit, an operation unit, a display unit, a communication unit, and a peripheral situation detection unit.

3. The work machine according to claim 1, further comprising:
a lower traveling body;
a rotating platform that turns with respect to the lower traveling body;
a boom that performs derricking with respect to the rotating platform; and
a hoisting rope suspended from the boom,
wherein the first member is the boom,
the work machine includes a drive unit that operates each unit of the work machine, and
the drive unit includes a derricking winch that performs derricking on the boom, a hoisting winch that winds or unwinds the hoisting rope, and a turning device that turns the rotating platform with respect to the lower traveling body.

4. The work machine according to claim 2,
wherein the operation unit includes a handle, a pedal, a lever, and a button, and outputs an operation signal corresponding to an operation content of the operation unit to the control unit.

5. The work machine according to claim 2,
wherein the control unit is a computer including a central processing unit (CPU) and an interface that exchanges data or a signal between a storage unit and an external device.

6. The work machine according to claim 2,
wherein the display unit displays an image or information of the suspended object and a work site around the suspended object, based on a display signal input from the control unit.

7. The work machine according to claim 2,
wherein the peripheral situation detection unit includes a detector that acquires an image around the work machine, three-dimensional positioning information, or both the image and the positioning information, and detects an obstacle located in a periphery of the work machine from the image, the positioning information, or both the image and the positioning information, which are acquired by the detector.

8. The work machine according to claim 1,
wherein the speed detection unit includes a camera that acquires an image of the suspended object by imaging the suspended object, and a function module that calculates a position, a positional change, and a speed of the suspended object from the image.

9. The work machine according to claim 8,
wherein the speed detection unit is suspended via an attachment tool on a tip side of a boom.

10. The work machine according to claim 9,
wherein the attachment tool includes a base portion fixed to the boom, a column whose one end is supported to be pivotable by the base portion, and a cover fixed to the other end of the column.

11. The work machine according to claim 1,
wherein in the drive control, the first member starts to be moved, based on a result that the speed reaches an extreme value.

12. The work machine according to claim 1,
wherein a control amount of the drive control is changed, based on the speed.

13. The work machine according to claim 1,
wherein the first member is a boom, and
the axial direction includes an X-axis direction along a turning direction of the boom, a Y-axis direction which is a horizontal component in a derricking and lowering direction of the boom, or both the X-axis direction and the Y-axis direction.

14. The work machine according to claim 1,
wherein a direction in which the first member is operated in the drive control is determined, depending on a peripheral situation of the work machine.

15. The work machine according to claim 1,
wherein the speed detection unit detects the shaking speed when the first member is stopped, and
the drive control is control to move and stop the first member from a state where the first member is stopped.
